(19) United States
(12) Patent Application Publication
(10) Pub. No.: US 2002/0067949 A1
(43) Pub. Date: Jun. 6, 2002

(54) Dispenser for personal use products

(76) Inventors: Joseph David Melnik, Keswick, VA (US); Andreia Cano, Jundiai (BR); Rogerio Costa, Lorena (BR)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 09/877,818

(22) Filed: Jun. 8, 2001

(30) Foreign Application Priority Data
Jun. 6, 2000 (BR) PI 0002340-0

(51) Int. Cl. B05C 11/00

(52) U.S. Cl. 401/266; 401/265; 401/205; 401/171

(57) ABSTRACT

A dispenser for personal use products to be applied to the user's body, of the type comprising a container (10) provided with a closed bottom wall (11) and an upper edge (12) affixing a perforated upper wall (40) made of a liquid impermeable flexible material, said container (10) having an amount of product (P) in gel or cream form; and a piston (20) provided inside the container (10) and being selectively and axially displaceable, by means of an actuator (30) mounted in the container (10), in order to expel a corresponding amount of product (P) through the perforated upper wall (40).

### A DISPENSER FOR PERSONAL USE PRODUCTS

1. Field of the Invention

The present invention refers to a dispenser for personal use products in gel or cream form, to be applied to the user's body, such as deodorants, antiperspirants, creamy lotions, insect repellents and sun blocks.

2. Background of the Invention

There are well known in the art the devices containing liquid products and which are elastically deformable by the user, in order to expel a certain amount of product in the form of a sprayed jet. Although guaranteeing good storage conditions and a soft and hygienic application, without requiring the contact of the device with the user's body, these “squeeze” type devices are not adequate to apply personal use products in gel or cream form.

A variant of the “squeeze” type devices is that in which the device comprises a container containing a pressurized liquid and provided with an upper valve which, when actuated, releases a jet of the product against the inner face of a head made of a usually sintered porous material and whose outer face is led to contact the user's body. In this case, besides requiring a dispensing construction, there is the limitation regarding the product, which must be in liquid form, as well as the inconvenience of applying to the body a rigid surface with little or no capacity for an anatomical adaptation to the different parts of he user's body.

Another known dispensing device is the so called “roll on” device, in which an applying sphere mounted so as to rotate in the opening of the device in contact with the stored product is caused to rotate in contact with the user's body, passing to the user the film of the product adhered to the sphere surface. Besides being only adequate to liquid or substantially liquid products, this “roll on” type device requires the user to press the sphere against the body to make it rotate and bring to the outside the product to be applied, causing a certain discomfort or even making unacceptable the use of the device in certain parts of the body, such as the face, neck, etc.

The prior art also includes those dispensing devices used for applying gel or cream to the body, basically comprising a container having a closed bottom wall and a perforated upper wall, and lodging a piston displaceable between an initial position, adjacent or seated onto the bottom wall of the container, and a plurality of extrusion positions, in which said piston expels from the container, through its upper perforated wall, an amount of product corresponding to the displacement imparted to the piston by a rod threaded through the piston and journalled to the bottom wall of the container, in order to be selectively and manually rotated by the user.

This type of dispensing device, which is well known in the field of the deodorants in gel or thick cream form, has positive operational results, in terms of containing and preserving the stored product and also in terms of controlling the amount to be expelled from the container to the outer surface of its perforated upper wall.

However, this type of extruding device for the product to be applied has the inconvenience of having its perforated upper wall, to be taken to contact the user's body, invariably constructed in a rigid material, for a better retention of the product stored in the container. However, this rigidity of the perforated upper wall avoids it from anatomically adapting or accommodating to the user's body during application of the product, making its use rather uncomfortable, even when applied to the axilla, or even unacceptable in more delicate regions of

### DISCLOSURE OF THE INVENTION

It is a general object of the present invention to provide a dispenser for personal use products in gel or cream form to be applied to the user's body and which allows, through a simple construction, the user to have good control of the amount of product to be applied through a soft and anatomically flexible surface of the dispenser.

The present dispenser is of the type comprising a container provided with a closed bottom wall and an upper edge affixing a perforated upper wall, said container containing an amount of product in gel or cream form; and a piston provided inside the container and selectively and axially displaceable, by actuation of an actuator mounted in the container, in order to expel a corresponding amount product through the perforated upper wall.

According to the invention, the perforated upper wall is defined by a perforated film made of a liquid impermeable flexible material, having its peripheral edge tightly affixed to the upper edge of the container and being dimensioned to slightly project, at least in part of its extension, outwardly from said upper edge when said film is internally pressed by the amount of product submitted to the action of the piston.

### BRIEF DESCRIPTION OF THE DRAWING

The invention will be described below, with reference to the attached drawing, in which:

FIG. 1 is an upper plan view of a dispenser constructed according to the present invention and without its usual upper cap; and

FIG. 2 is a cross-sectional view of the present dispenser, said view being taken according to line II-II of FIG. 1 and including in dashed lines, the upper cap in an exploded position.

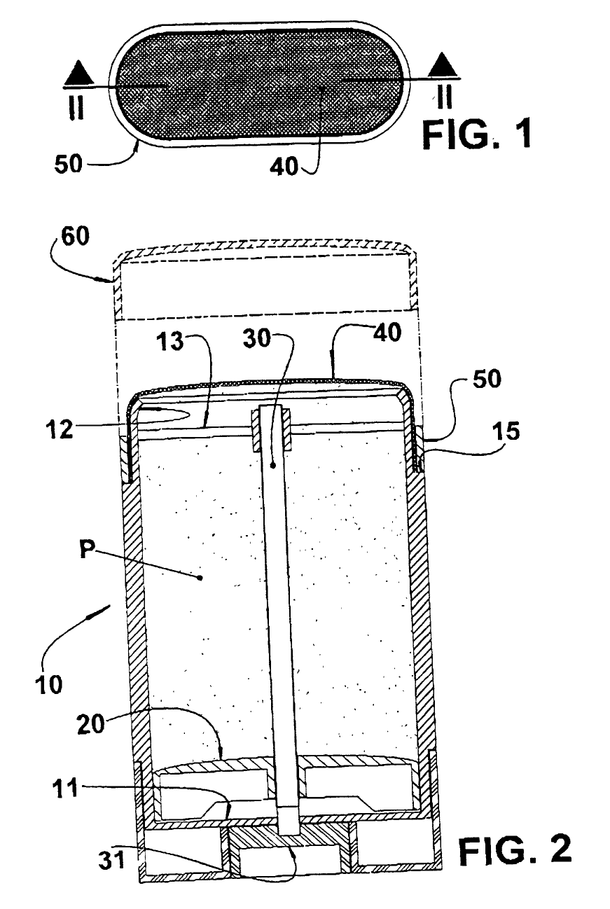

### BEST MODE OF CARRYING OUT THE INVENTION

As illustrated in the appended drawing, the present dispenser comprises a container 10, generally made of a transparent plastic material, at least in its lateral faces, and having, preferably, an elongated rectangular horizontal cross section, with the smaller sides being rounded and coinciding with the lateral walls of the container 10.

The container 10 is provided with a closed bottom wall 11 and with an upper wall 12 surrounding a respective open upper opening of the container 10. Inside the container 10 is mounted a piston 20, axially displaceable by means of an actuator mounted in the container and accessible to the user. In the illustrated embodiment, the actuator takes the form of a threaded rod 30, whose lower end is journalled through the bottom wall 11 in order to receive, in its portion external to the container, a small knob 31, through which the user may rotate the rod 30, whose upper end is journalled to a support 13 affixed inside the container 10, just below its upper edge 12.

The rod 30 is provided through a respective threaded median portion of the piston 20, allowing the latter to be axially and selectively displaced from an inoperative position, adjacent to the bottom wall 11, and a plurality of extrusion positions, upwardly displaced according to the rotation imparted to the knob 31 by the user.

It should be understood that different means may be used to axially displace the piston 20, without departing from the scope of the present invention.

The inside of the container 10 defined above the piston 20 is filled with an amount of product P in gel or cream form to be impelled towards the upper opening of the container 10 upon displacement of the piston 20.

According co the invention, the upper edge 12 of the container 10 is tightly affixed to the peripheral edge of an upper wall defined by a perforated film 40 of a liquid impermeable material, such as the films produced by thermoplastic polymers in general (low density polymers, medium density polymers, high density polymers, polypropylene, polyamides, polyurethanes, etc), which may be in the natural (transparent), opaque or colored forms, with a perforation pattern from 10% to 60% of perforated area, preferably from 30% to 40% of perforated area, and a thickness between 20 and 1000 micrometers, preferably between 200 and 800 micrometers, and more preferably between 400 and 600 micrometers.

The perforated film 40 is designed to slightly project, at least in part of its extension, outwardly from the upper edge 12 of the container 10 when said edge is internally pressed by the amount of product P submitted to the action of the piston 20, as illustrated in FIG. 2.

In the illustrated embodiment, the container 10 is provided with an upper peripheral recess 15, upon which is fitted the peripheral portion of the perforated film 40, this peripheral portion being retained by a ring 50, which is tightly fitted into said upper peripheral recess 15, said ring 50 being further dimensioned to receive the lower edge of a cap 60 of adequate construction.

1. A dispenser for personal use products to be applied to the user's body, of the type comprising a container (10) provided with a closed bottom wall (11) and an upper edge (12) affixing a perforated upper wall (40), said container (10) containing an amount of product (P) in gel or cream form; and a piston (20) provided inside the container (10) and selectively and axially displaceable, by actuation of an actuator (30) mounted in the container (10), in order to expel a corresponding amount of product (P) through the perforated upper wall (40), characterized in that the perforated upper wall (40) is defined by a perforated film of a liquid impermeable flexible material, having its peripheral edge tightly affixed to the upper edge (12) of the container (10) and being dimensioned to slightly project, at least in part of its extension, outwardly from said upper edge (12) when said film is internally pressed by the amount of product (P) submitted to the action of the piston (20).

2. The dispenser of claim 1, characterized in that the retention of the peripheral edge of the upper perforated wall (40) to the container (10) is obtained by pressing said peripheral edge, by means of a ring (50), against an upper peripheral recess (15) provided externally to the container (10).
